(19) United States
(12) Patent Application Publication
(10) Pub. No.: US 2026/0101886 A1
(43) Pub. Date: Apr. 16, 2026

(54) METHOD AND SYSTEM FOR A NORMOTHERMIC MACHINE PERFUSION OF AN EX VIVO LIVER

(71) Applicant: MEDIZINISCHE UNIVERSITÄT INNSBRUCK, Innsbruck (AT)

(72) Inventors: Stefan SCHNEEBERGER, Innsbruck (AT); Thomas RESCH, Innsbruck (AT)

(21) Appl. No.: 19/145,791

(22) PCT Filed: Jan. 4, 2024
(86) PCT No.: PCT/EP2024/050177

§ 371 Date: Jul. 3, 2025

(30) Foreign Application Priority Data
Jan. 4, 2023 (EP) 23150338.4

(51) Int. Cl. A01N 1/143; A01N 1/124

(52) U.S. Cl. CPC A01N 1/143; A01N 1/124

(57) ABSTRACT

A method and a system for a normothermic machine perfusion of an ex vivo liver is provided. The method comprises the following steps: (a) generating a flow of a perfusate through an ex vivo liver, (b) stimulating a bile secretion of the ex vivo liver, and (c) determining a volume of bile secreted by the ex vivo liver, and subsequently adding an oxygen carrier, e.g., whole blood to the perfusate, wherein the added oxygen carrier has a volume that equals at least 20% of the determined volume of secreted bile.

The present disclosure relates to a method and a system for a normothermic machine perfusion (NMP) of an ex vivo liver.

Liver transplantation represents the only curative approach for patients with an organ liver failure. The imbalance between the number of available organs and the increasing number of patients on corresponding waiting lists remains the Achilles heel in organ transplantation. In 2015, waitlist mortality in the Eurotransplant region was as high as 18%. In an attempt to mitigate this dilemma, marginal organs from extended criteria donors (ECD), therefore donors at a higher age and with various comorbidities are increasingly used. The challenge, however, remains in the determination whether such grafts are suitable for transplantation or should rather be discarded.

Normothermic machine perfusion represents a novel technology that can effectively reduce ischemia reperfusion injury (IRI) compared to the traditional cold static preservation of organs. This is of particular interest concerning ECD livers due to the fact that these organs are particularly prone to IRI. Importantly, apart from an optimization of organ preservation, NMP offers a second possible advantage. Since the metabolism of cells preserved at body temperature is fully active, NMP potentially provides the opportunity to assess the quality of an ECD graft during the perfusion process. In 2018, Nasralla et al. could show that this advantage resulted in a 50% lower rate of organ discard (Nasralla, D., et al. Nature 557, 50-56 (2018)). Since then, liver NMP has been adapted in the clinical routine setting at various transplant centers, including a unit at the Medical University of Innsbruck. Excellent outcomes for ECD and DCD (DCD: donation after circulatory death) grafts were observed by Cardini et al. (Cardini, B., et al. Transplantation 104, 1917-1928 (2020).

However, normothermic preservation of livers is limited to short-term periods, namely approximately 24 hours. Specifically, even though improved utilization of ECD grafts has been demonstrated, this short-term NMP alone is not sufficient to meet the extensive demand of organs.

WO 2019/141809 A1 relates to a perfusion loop assembly for an ex vivo liver perfusion. The assembly comprises at least one pump for providing a fluid flow of a perfusion fluid through a line that branches into a first branch line and a second branch line downstream of the pump. Also described is a method for stimulating bile production, and a spectroscopic method for measuring cellular signal molecules to characterize ischemic injury.

There is a need to provide an improved method and an improved system for a NMP, particularly a corresponding method and system by which the availability of liver transplants can be improved.

This object is achieved by the independent claims. Dependent claims refer to preferred embodiments. Additional or alternative aspects of the present disclosure are addressed throughout this specification.

### SUMMARY

According to the present disclosure, a method for a normothermic machine perfusion of an ex vivo liver is provided that comprises the following steps: (a) generating a flow of a perfusate through an ex vivo liver, (b) stimulating a bile secretion of the ex vivo liver, and (c) determining a volume of bile secreted by the ex vivo liver, and subsequently adding whole blood to the perfusate, wherein the added blood has a volume that equals at least 20% of the determined volume of secreted bile.

More generally, step (c) may comprise determining a volume of bile secreted by the ex vivo liver, and subsequently adding an oxygen carrier to the perfusate, wherein the added oxygen carrier has a volume that equals at least 20% of the determined volume of secreted bile. The oxygen carrier may comprise or consist of, e.g., whole blood and/or red blood cells. Preferably, the oxygen carrier is added in step (c) to substitute for the loss of bile, i.e. to substitute the secreted bile.

The oxygen carrier may comprise whole blood for example in a porcine setting. The oxygen carrier may comprise red blood cells (erythrocytes) in a human setting.

The method enables a novel translational and reproducible protocol for a long-term NMP of an ex vivo liver. The method specifically allows for a successful long-term NMP for up to seven days. Further, use of the method allows the maintenance of both, morphological as well as functional integrity of for example porcine livers outside the body over a time frame of one week.

Further, apart from organ preservation and quality assessment in the short-term application, long-term NMP over several days makes it possible to establish appropriate conditions for organ reconditioning and treatment. In this way, interventions during such prolonged NMP can focus on a regeneration of quality and function, allowing the utilization of marginal organs that otherwise would have been deemed unsuitable and discarded. In this regard, the method according to the present description offers a previously non-existent link between basic and clinical science and the opportunity to treat a corresponding organ during preservation, creating a new field of translational research.

The method not only manages to achieve a particularly suited replacement of fluid or perfusate lost through bile output but also a drug and blood product regiment which achieves effective long-term maintenance of liver viability and function.

It is noted that no dialyzer is required for carrying out the method.

The following description refers to porcine livers. However, it is noted that the method and system described herein are generally as well suited in case of human livers, if necessary, under appropriate adjustments.

Various embodiments may implement the following features:

In step (c), the added oxygen carrier, e.g., whole blood, may have a volume that equals at least 30%, preferably at least 40%, preferably at least 50%, preferably at least 60%, preferably at least 70%, preferably at least 75%, preferably at least 80%, preferably at least 85%, preferably at least 90%, preferably at least 95%, preferably at least 100% and/or up to 120% of the determined volume of secreted bile. In this way, a volume of the perfusate may be held within a certain predetermined volume range. The predetermined volume range may have a lower limit of for example 0.9 L.

Generally, the higher the percentage of the added oxygen carrier, the longer the period over which the ex vivo liver can be kept functioning. For example, a value of at least 70% has been found to maintain functionality for a period of about seven days. A minimum value of 50% is suitable for a somewhat shorter period.

The whole blood may have a blood group that corresponds to the blood group that the blood of the donor animal from which the liver was taken had. By adding whole blood within step (c), it is possible to achieve that a suitable minimum amount of hemoglobin is present in the perfusate during the procedure. Preferably, the whole blood which is added in step (c) is a fresh blood.

The perfusate may consist of a corresponding whole blood.

Preferably, the ex vivo liver is held within a temperature range having a lower limit of at least 28° C., preferably at least 30° C., preferably at least 32° C., preferably at least 34° C., preferably at least 36° C. The temperature range may be 34° C.±5 K, preferably 34° C.±3 K.

In step (c) determining a volume of bile secreted by the ex vivo liver may comprise measuring a volume of bile secreted by the ex vivo liver.

The measuring can be carried out for example by using a sensor provided at a bile duct tube which is connected to the ex vivo liver accordingly, i.e. for example to the bile duct of the ex vivo liver. Also, external sensors, such as scales, or optical sensors such as measuring scales or a camera may be used.

In step (c) determining a volume of bile secreted by the ex vivo liver may comprise estimating a volume of bile secreted by the ex vivo liver. Estimating a volume of bile secreted by the ex vivo liver may be carried out in advance based on experience values, for example based on experience values in dependence on a mass of the ex vivo liver and/or a size of the ex vivo liver.

Step (c) may be carried out at least twice, preferably at least three times, preferably at least four times, preferably at least five times, preferably at least six times, preferably at least eight times, preferably at least ten times, preferably at least twelve times, preferably at least fourteen times.

Bile flow is related to the functional health of the liver. Mechanistically, bile flow requires liver oxygen availability, blood flow, and energy metabolism. A healthy transplantable liver with bile flow reflects the ability of the liver to perform essential metabolic processes. Tight determination of the “bile production rate and/or bile composition” is thus considered advantageous in the sense that the “volume balance” of the perfusate can be better controlled in a time and volume-controlled manner. Liver dysfunction is avoided, and liver health preserved over longer periods of time.

Against this background, it is advantageous if an intervention to stabilise or improve the condition or state of the liver is carried out as quickly as possible once the bile production rate has decreased. Experience has shown that this is particularly relevant in a second phase of the method, for example from around the third day. Until then, corresponding intervention measures or steps, for example in the form of steps (b) and/or steps (c), may be carried out at equal time intervals. For example, step (c) may be repeated every 24 hours and the time intervals may be reduced as soon as the bile production rate has fallen, in particular by at least a certain level. For example, a value between −1 mL/h and −100 mL/h, preferably between −1 mL/h and −50 mL/h may be selected as the corresponding predetermined level.

To this end, the method may comprise a step of determining a time development of a bile production rate, wherein, based on this, a point in time is determined at which a subsequent method step for influencing the state of the ex vivo liver is carried out. A bile production rate may be determined specifically as volume per time interval or as mass per time interval. The subsequent method step for influencing the state of the ex vivo liver may be a step to stabilise or improve the condition or state of the ex vivo liver, for example in the form of stimulating a bile secretion of the ex vivo liver, preferably according to step (b) and/or adding an oxygen carrier, preferably according to step (c). A further or additional or alternative possible method step for influencing the state of the ex vivo liver may be to vary the flow of the perfusate through the ex vivo liver, for example by varying a performance of a pump for generating the flow of the perfusate.

More specifically, if it is determined that the bile production rate has decreased, the more the bile production rate has decreased, the closer the point in time for carrying out the subsequent method step for influencing the state of the ex vivo liver may be chosen to the point in time at which the time development of the bile production rate has been determined.

Bile production rates may be determined at times that are less than 36 hours apart, for example less than 12 hours apart or less than six hours apart or less than three hours apart. For example, bile production rates may be determined at times that are one hour or less apart, respectively.

For example, step (c) may be carried out a plurality of times, wherein bile production rates are determined on the basis of the determined volumes of bile and the times at which the steps (c) were carried out. However, a bile production rate or bile production rates may alternatively be determined independent of step (c) or steps (c), e.g. at different times and/or in a different way.

The bile production rate may be determined and/or step (c) may be carried out i times, with i is a natural number greater than 2, at successive times t₁ to tᵢ, i.e. a sequence of bile production determinations and/or steps (c)(t₁) to c(tᵢ), whereby time tₖ, with 3≤k≤i, is determined in dependence on the preceding times tₖ₋₂ and tₖ₋₁ and the volumes of bile measured at the preceding bile production determinations and/or steps (c)(tₖ₋₂) and (c)(tₖ₋₁).

A first bile production rate between time tₖ₋₂ and a preceding time to and a second bile production rate between time tₖ₋₂ and tₖ₋₁ may be determined and, if the second bile production rate is smaller than the first bile production rate, tₖ may be determined such that tₖ minus tₖ₋₁ is less than tₖ₋₁ minus tₖ₋₂. This allows ensuring that the oxygen carrier is added to the perfusate appropriately when the bile production rate drops.

While the time intervals between tₖ₋₂ and tₖ₋₁ as well as between tₖ₋₂ and to do not need to be identical, they do preferably substantially correspond. The time interval between tₖ and tₖ₋₁ may be adapted, in particular shortened, based in line with the above. In case of an increase of the bile production rate, no changes in rhythm of stimulation (e.g. step (b)) or adding of oxygen carrier (e.g. step (c)) may be necessary. Particularly if the time intervals had been reduced, they may be increased in reaction of increasing bile production rate.

Step (b) may be carried out at least twice, preferably at least three times, preferably at least four times, preferably at least five times, preferably at least six times, preferably at seven times.

Step (b) and/or step (c) may be carried out respectively once within a predetermined time interval. The time interval may be between 1 hour and 48 hours, preferably between 3 hours and 36 hours, preferably between 6 hours and 24 hours, preferably between 9 hours and 18 hours. For example, step (b) may be carried out once within 24 hours. For example, step (c) may be carried out once within 12 hours.

The method may be carried out over a period of at least three days, preferably at least four days, preferably at least five days, preferably at least six days, preferably at least seven days.

The method may further comprise a step (d) of flushing a bile duct tube connected to the ex vivo liver, e.g. to the bile duct of the ex vivo liver. Step (d) may comprise flushing a volume of a flushing fluid, for example comprising saline, through the bile duct tube. Since bile is a viscous liquid, there is a risk of obstruction of a corresponding bile duct tube. This risk can be reduced or even eliminated by flushing the bile duct correspondingly.

The volume of the flushing fluid may be taken into consideration when determining the volume of bile secreted by the ex vivo liver in step (c) carried out after step (d).

Step (d) may be carried out once within a predetermined time interval. The time interval in which step (d) is carried out once may be between 1 hour and 48 hours, preferably between 3 hours and 36 hours, preferably between 6 hours and 24 hours, preferably between 9 hours and 18 hours.

Step (c) may be carried out after step (d). Step (c) and step (d) may be each carried out several times, namely step (c) after step (d) in each case.

In step (b) a bile salt or a derivative thereof may be used for stimulating the bile secretion. The bile salt may comprise or may be sodium taurocholate and/or sodium glycocholate.

The bile salt may be administered to the perfusate in a dosage of up to 6 g per 24 hours, preferably up to 4 g per 24 hours, for example up to 3 g per 24 hours. The average dosage of bile salt (12) per day, administered during the period the method is carried out, may be less than 5 g, preferably less than 4 g and more preferably between 2 and 2.5 g.

Before step (b) is carried out, a bile secretion of the ex vivo liver per time may be determined, for example by measuring or estimating, and step (b) may be controlled in dependence on the determined bile secretion per time. Particularly a specific dosage of bile salt or a derivative thereof to be administered subsequently in step (b) may be selected in dependence on the determined bile secretion per time. In this way, the stimulation of bile secretion or bile production can be suitably controlled. For example, bile secretion can be held within a certain desired range, such as for example within 100 and 1000 mL per day, preferably within 200 and 900 mL per day. It is noted that a typical value of bile production in humans is 750 mL per day.

The determination of bile secretion per time may be advantageously carried out by using the volume of bile secreted by the ex vivo liver in a step (c) or, as the case may be, in one of steps (c) carried out prior to the respective step (b).

The method may further comprise the following step: (e) administering an antibiotic or a combination of antibiotics to the perfusate. Step (d) may comprise administering an antibiotic or a combination of antibiotics and an antifungal agent to the perfusate. It has been shown that in this way the viability of the liver cells can be preserved in a particularly suitable manner. This has particular significance if the method is carried out over several days.

The antibiotic or combination of antibiotics may comprise or consists of meropenem and/or vancomycin.

The antibiotic or combination of antibiotics may further comprise piperacillin.

Step (d) may further comprise administering a beta-lactamase-inhibitor, for example tazobactam.

The antifungal agent may comprise or may be fluconazole.

Step (d) may be carried out once within a predetermined time period, for example once a day.

For example, a dosage between 0.6 g and 1.2 g piperacillin and/or tazobactam may be administered within 24 hours, preferably a dosage between 0.7 g and 1.1 g, more preferably between 0.8 g and 1.0 g.

In step (d) vancomycin may be administered adapted to a perfusate target value of 10 mg/L to 20 mg/L.

In step (d), a dosage between 8 mg and 12 mg meropenem per kg liver weight may be administered within 24 hours, preferably a dosage between 9 mg and 11 mg.

In step (d), a dosage between 10 mg and 14 mg fluconazole per kg liver weight may be administered within 24 hours, preferably a dosage between 11 mg and 13 mg.

The method may further comprise a glucose management, for example by administering glucose (e.g. 33%) in dosages of 10 mL if glucose levels drop below 15 mg/dL. The glucose management may further comprise administering insulin, for example in dosages of 200 IU ad 30 mL saline, for example 1.25 mL per hour continuously.

The method may further comprise a vasodilation management, for example by administering epoprostenol and/or prostacyclin, for example in dosages of 0.5 mg per 10 mL glycin buffer per 30 mL saline, for example 1.25 mL per hour continuously.

The method may further comprise a nutrition management, for example by administering Nutriflex® parenteral nutrition formula, for example in dosages of 1000 mL, for example 1.25 mL per hour continuously.
that equals 20% to 120% of the volume of the secreted bile, further preferred 30% to 100% The method may further comprise a pH control management, for example by administering sodium bicarbonate, for example in dosages of 20 mL.

The method may further comprise an anticoagulation management, for example by administering high molecular weight heparin, for example in dosages of 25 000 iU per 30 mL saline, for example 1.25 mL per hour continuously.

According to another aspect of the present description, a method for a normothermic machine perfusion of an ex vivo liver is provided that comprises the following steps: (a) generating a flow of a perfusate through an ex vivo liver, (b) stimulating a bile secretion of the ex vivo liver, and (c′) adding an oxygen carrier, for example whole blood or red blood cells to the perfusate such that a volume of the perfusate is held within a predetermined volume range. A lower limit of the volume range may be 0.9 L, preferably 1.0 L, preferably 1.2 L, preferably 1.4 L. The added oxygen carrier may have a volume that equals a certain percentage of the volume of the secreted bile. Preferably, the added oxygen carrier may have a volume that equals 20% to 120% of the volume of the secreted bile, further preferred 30% to 100%.

Step (c′) may comprise determining the volume of perfusate currently received in the perfusate container. Determining the volume of perfusate currently received in the perfusate container may comprise measuring or estimating the volume of perfusate currently received in the perfusate container.

The above specifications with reference to the first-mentioned method also apply mutatis mutandis to this method.

It is noted that the above effects described with reference to the first-mentioned method can also be achieved by this method. Therefore, the two methods involve alternative solutions to a particular problem.

According to a further aspect of the present description, a system for a normothermic machine perfusion of an ex vivo liver is provided, particularly a system for carrying out a method as described herein. The system comprises a perfusate container for receiving a perfusate, an ex vivo liver container for holding the ex vivo liver, a pump for generating a flow of the perfusate through the ex vivo liver, means for determining a volume of bile secreted by the ex vivo liver, and/or means for determining a bile production rate.

The means for determining a volume of bile secreted by the ex vivo liver particularly allow determining a volume of bile secreted by the ex vivo liver, and subsequently adding an oxygen carrier (e.g., whole blood) to the perfusate, wherein the added oxygen carrier (e.g. whole blood) has a volume that equals at least 70% of the determined volume of secreted bile.

The system may further comprise a bile container for receiving a volume of bile secreted by the ex vivo liver.

The system may further comprise as least one sensor for measuring a volume of bile.

Such sensor may be scales, a measuring scale, and/or a camera.

The system may further comprise an oxygenator for oxygenating the perfusate. The oxygenator may be configured to oxygenate the perfusate for at least four days, preferably at least five days, preferably at least six days, preferably at least seven days.

The system may further comprise means for generating a bile alarm if the volume of bile determined by the means for determining a volume of bile reaches a predetermined upper threshold value. In this manner, a user of the system can be warned if bile production becomes higher than desired.

The system may further comprise means for determining a volume of the perfusate held in the perfusate container. The system may further comprise means for generating a perfusate alarm if the volume of perfusate determined by the means for determining a volume of the perfusate held in the perfusate container reaches a predetermined lower threshold value. In this manner, a user of the system can be warned in due time if there is a risk that the amount of perfusate in the perfusate container will fall below a desired minimum value.

The system may further comprise a tubing for connecting the perfusate container to the ex vivo liver and to the pump.

The system may further comprise at least one flow sensor connected to the tubing for determining a flow of perfusate.

The system may further comprise an ascites recirculation unit for recirculation of ascites emitted or delivered from an outer surface of the ex vivo liver to the perfusate container.

The system may further comprise a blood gas sensor connected to the tubing, preferably between a first tubing portion for delivering the perfusate to the ex vivo liver and a second tubing portion for transporting the perfusate away from the ex vivo liver.

The system may further be automatically controlled, e.g., including a processor adapted and arranged to perform a method as described herein.

The system may be configured to carry out a method according to the present description, further comprising means for automatically carrying out the steps of the method. For example, the system may comprise a controller configured to automatically control steps (a) to (c).

In particular, the present disclosure comprises the following aspects:
1A. A method for a normothermic machine perfusion of an ex vivo liver, comprising the following steps:
   (a) generating a flow of a perfusate through an ex vivo liver,
   (b) stimulating a bile secretion of the ex vivo liver,
   (c) determining a volume of bile secreted by the ex vivo liver, and subsequently adding an oxygen carrier, for example an oxygen carrier comprising or consisting of whole blood and/or red blood cells to the perfusate, wherein the added oxygen carrier has a volume that equals at least 20% of the determined volume of secreted bile.
1B. The method of aspect 1A, wherein in step (c), the added oxygen carrier, e.g., whole blood has a volume that equals at least 30%, preferably at least 40%, preferably at least 50%, preferably at least 60%, preferably at least 70%, preferably at least 75%, preferably at least 80%, preferably at least 85%, preferably at least 90%, preferably at least 95%, preferably at least 100% of the determined volume of secreted bile.
2A. A method for a normothermic machine perfusion of an ex vivo liver, comprising the following steps:
   (a) generating a flow of a perfusate through an ex vivo liver,
   (b) stimulating a bile secretion of the ex vivo liver,
   (c′) adding an oxygen carrier, for example an oxygen carrier comprising or consisting of whole blood to the perfusate such that a volume of the perfusate is held within a predetermined volume range.
2B. The method of aspect 2A, wherein a lower limit of the volume range is 0.9 L, preferably 1.0 L, preferably 1.2 L, preferably 1.4 L.
3. The method of any of the preceding aspects, wherein in step (c) determining a volume of bile secreted by the ex vivo liver comprises measuring a volume of bile secreted by the ex vivo liver.
4. The method of any of the preceding aspects, wherein in step (c) determining a volume of bile secreted by the ex vivo liver comprises estimating a volume of bile secreted by the ex vivo liver.
5. The method of any of the preceding aspects, wherein step (c) is carried out at least twice, at least three times, preferably at least four times, preferably at least five times, preferably at least six times, preferably at least eight times, preferably at least ten times, preferably at least twelve times, preferably at least fourteen times.
6. The method of any of the preceding aspects, wherein a time development of a bile production rate is determined and, based on this, a point in time is determined at which a subsequent method step for influencing the state of the ex vivo liver, for example in the form of stimulating a bile secretion of the ex vivo liver, preferably according to step (b) and/or adding an oxygen carrier, preferably according to step (c), is carried out.
7. The method of aspect 6, wherein, if it is determined that the bile production rate has decreased, the more the bile production rate has decreased, the closer the point in time for carrying out the subsequent method step for influencing the state of the ex vivo liver is chosen to the point in time at which the time development of the bile production rate has been determined.
8. The method of any of aspects 6 to 7, wherein bile production rates are determined at times that are less than 36 hours apart, for example less than 12 hours apart, for example less than six hours apart, for example less than three hours apart.
9. The method of any of the preceding aspects, wherein step (c) is carried out a plurality of times, wherein bile production rates are determined on the basis of the determined volumes of bile and at the times at which the steps (c) are carried out.
10. The method of any of the preceding aspects, wherein step (c) is carried out i times, wherein i is a natural number greater than 2, at successive times t₁ to tᵢ, i.e. a sequence of steps (c)(t₁) to c(tᵢ), whereby time tₖ, with 3≤k≤i, is determined depending on the preceding times tₖ₋₂ and tₖ₋₁, and the volumes of bile measured at the preceding steps (c)(tₖ₋₂) and (c)(tₖ₋₁).
11. The method of aspect 10, wherein a first bile production rate between time tₖ₋₂ and a preceding time to and a second bile production rate between time tₖ₋₂ and tₖ₋₂ are determined and, if the second bile production rate is smaller than the first bile production rate, tₖ is determined such that tₖ minus tₖ₋₁ is less than tₖ₋₁ minus tₖ₋₂.
12. The method of any of the preceding aspects, wherein step (b) is carried out at least twice, at least three times, preferably at least four times, preferably at least five times, preferably at least six times, preferably at least seven times.
13. The method of any of the preceding aspects, wherein step (b) and/or step (c) is or are carried out once respectively within a predetermined time interval.
14. The method of aspect 13, wherein the time interval is between 1 hour and 48 hours, preferably between 3 hours and 36 hours, preferably between 6 hours and 24 hours, preferably between 9 hours and 18 hours.
15. The method of any of the preceding aspects, wherein the method is caried out over a period of at least three days, preferably at least four days, preferably at least five days, preferably at least six days, preferably at least seven days.
16. The method of any of the preceding aspects, further comprising a step (d) of flushing a bile duct tube connected to the ex vivo liver, e.g. to the bile duct of the ex vivo liver.
17. The method of aspect 16, wherein step (d) is carried out once within a predetermined time interval.
18. The method of aspect 17, wherein the time interval in which step (d) is carried out once is between 1 hour and 48 hours, preferably between 3 hours and 36 hours, preferably between 6 hours and 24 hours, preferably between 9 hours and 18 hours.
19. The method of any of aspects 16 to 18, wherein step (c) is carried out after step (d).
20. The method of any of aspects 16 to 19, wherein step (d) comprises flushing a volume of a flushing fluid, for example comprising saline, through the bile duct tube, wherein, preferably, the volume of the flushing fluid is taken into consideration when determining the volume of bile secreted by the ex vivo liver in step (c) carried out after step (d).
21. The method of any of aspects 16 to 20, wherein step (c) and step (d) are each carried out several times, namely step (c) after step (d) in each case.
22. The method of any of the preceding aspects, wherein in step (b) a bile salt or a derivative thereof is used for stimulating the bile secretion.
23. The method of aspect 22, wherein the bile salt comprises or is sodium taurocholate and/or sodium glycocholate.
24. The method of aspect 22 or 23, wherein the bile salt is administered to the perfusate in a dosage of up to 6 g per 24 hours, preferably up to 4 g per 24 hours, for example up to 3 g per 24 hours, and/or, wherein the average dosage of bile salt (12) per day, administered during the period the method is carried out, is less than 5 g, preferably less than 4 g and more preferably between 2 and 3 g.
25. The method of any of the preceding aspects, wherein, before step (b) is carried out, a bile secretion of the ex vivo liver per time is determined, for example measured or estimated, and step (b) is controlled in dependence on the determined bile secretion per time, particularly by selecting a specific dosage of bile salt or a derivative thereof to be administered subsequently in step (b).
26. The method of any of the preceding aspects, further comprising the following step:
   (e) administering an antibiotic or a combination of antibiotics to the perfusate (2).
27. The method of aspect 26, wherein step (d) further comprises administering an antifungal agent to the perfusate, for example fluconazole.
28. The method of aspect 26 or 27, wherein the antibiotic or combination of antibiotics comprises or consists of meropenem and/or vancomycin and/or piperacillin.
29. The method of any of aspects 26 to 28, wherein step (d) further comprises administering a beta-lactamase-inhibitor, for example tazobactam.
30. The method of any of aspects 26 to 29, wherein in step (d) a dosage between 0.6 g and 1.2 g piperacillin and/or tazobactam are administered within 24 hours, preferably a dosage between 0.7 g and 1.1 g, more preferably between 0.8 g and 1.0 g.
31. The method of any of aspects 26 to 30, wherein vancomycin is administered adapted to a perfusate target value of 10 mg/L to 20 mg/L.
32. The method of any of aspects 26 to 31, wherein a dosage between 8 mg and 12 mg meropenem per kg liver weight is administered within 24 hours, preferably a dosage between 9 mg and 11 mg.
33. The method of any of aspects 26 to 32, wherein a dosage between 10 mg and 14 mg fluconazole per kg liver weight is administered within 24 hours, preferably a dosage between 11 mg and 13 mg.
34. A system for a normothermic machine perfusion of an ex vivo liver, particularly system for carrying out a method of any of the preceding aspects, comprising
   a perfusate container for receiving a perfusate,
   an ex vivo liver container for holding the ex vivo liver,
   a pump for generating a flow of the perfusate through the ex vivo liver,
   means for determining a volume of bile secreted by the ex vivo liver, and/or
   means for determining a bile production rate.
35. The system of aspect 34, further comprising
   a bile container for receiving a volume of bile secreted by the ex vivo liver.
36. The system of aspect 34 or 35, further comprising
   means for generating a bile alarm if the volume of bile determined by the means for determining a volume of bile reaches a predetermined upper threshold value.
37. The system of any of aspects 34 to 36, further comprising
   means for determining a volume of perfusate held in the perfusate container.
38. The system of aspect 37, further comprising
   means for generating a perfusate alarm if the volume of perfusate determined by the means for determining a volume of perfusate held in the perfusate container reaches a predetermined lower threshold value.
39. The system of any of aspects 34 to 38, further comprising
   an oxygenator for oxygenating the perfusate, wherein preferably the oxygenator is configured to oxygenate the perfusate for at least four days, preferably at least five days, preferably at least six days, preferably at least seven days.
40. The system of any of aspects 34 to 39, further comprising
   a tubing for connecting the perfusate container to the ex vivo liver and to the pump.
41. The system of aspect 40, further comprising
   at least one flow sensor connected to the tubing for determining a flow of perfusate.
42. The system of any of aspects 34 to 41, further comprising
   an ascites recirculation unit for recirculation of ascites emitted or delivered from an outer surface of the ex vivo liver to the perfusate container.
43. The system of any of aspects 34 to 42, further comprising
   a blood gas sensor connected to the tubing, preferably between a first tubing portion for delivering the perfusate to the ex vivo liver and a second tubing portion for transporting the perfusate away from the ex vivo liver.
44. The system of any of aspects 34 to 43, the system being configured to carry out a method of any of aspects 1 to 33, further comprising means for automatically carrying out the steps of the method.

### SHORT DESCRIPTION OF THE DRAWINGS

The subject-matter of the disclosure will be explained in more detail with reference to preferred exemplary embodiments which are illustrated in the attached drawings, in which:

FIG. 1 is a schematic view of a system for a NMP of an ex vivo liver according to the present description.

FIG. 2 is a diagram showing a bile production over time, measured during a method according to the present description.

FIG. 3 is a diagram showing an alanine-aminotransferase level over time, measured during a method according to the present description.

FIG. 4 shows a diagram illustrating liver survival over time according to the present method compared to liver survival without using such a method.

### DETAILED DESCRIPTION

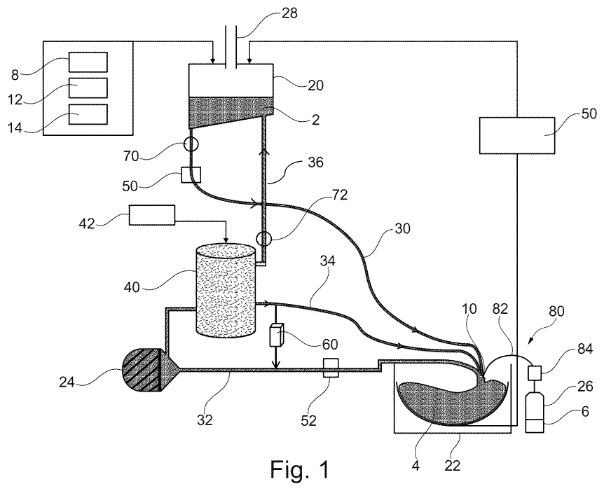

FIG. 1 a is a schematic view of a system for a NMP of an ex vivo liver 4 as described herein. The system comprises a perfusate container 20 for receiving a perfusate 2. The perfusate 2 is suited to be perfused through an ex vivo liver 4. The perfusate container 20 may be a pouch or a bag. Preferably, the perfusate container 20 comprises an opening 28 for filling perfusate 2. The opening 28 may comprise for example an inlet port. The opening 28 is preferably configured in such a way that it can be opened and closed in a repeated manner.

The system further comprises an ex vivo liver container 22 for receiving the ex vivo liver 4.

The system further comprises a pump 24 for generating a flow of perfusate 2 through the ex vivo liver 4. Preferably, the system further comprises an oxygenator 40 for oxygenating the perfusate 2. Preferably, the oxygenator 40 is configured to oxygenate the perfusate 2 for several days, for example for at least three days, more preferably for at least four days. For example, the oxygenator 40 is configured to oxygenate the perfusate 2 for at least seven days.

Further, an oxygen source 42 may be connected to the oxygenator 40 for providing the oxygenator 40 with oxygen and/or air.

Further, the system may comprise a tubing 30, 32, 34, 36 for connecting the perfusate container 20, the pump 24 and the oxygenator 40 to the ex vivo liver 4 such that the pump 24 may cause perfusate 2 to circulate through the tubing 30, 32, 34, 36 and through the ex vivo liver 4. Specifically, the tubing 30, 32, 34, 36 may comprise a first tube 30 configured to connect the perfusate container 20 to the ex vivo liver 4, a second tube 32 configured to connect the ex vivo liver 4 to the pump 24, and a third tube 34 configured to connect the oxygenator 40 to the ex vivo liver 4. Moreover, the tubing 30, 32, 34, 36 may further comprise a fourth tube 36 configured to connect the oxygenator 40 to the perfusate container 20. The tubing 30, 32, 34, 36 preferably is made of or at least comprises an ultraviolet radiation impermeable material. In this way, the perfusate 2 can be protected particularly from daylight.

A flow sensor and bubble detector 50 may be provided at the first tube 30 configured to measure a flow of perfusate 2 through the first tube 30 and to detect bubbles in the perfusate 2. A further flow sensor 52 may be provided at the second tube 32 configured to measure a flow of perfusate 2 through the second tube 32.

A gas analyzer 60 may be provided between the second tube 32 and the third tube 34 configured to analyze at least one gas component of the perfusate 2 such as for example oxygen and/or carbon dioxide.

Moreover, a first valve 70, preferably a pinch valve, may be provided in the first tube 30 and a second valve 72, preferably a pinch valve, may be provided in the fourth tube 36.

Further, the system may comprise an ascites recirculation unit 50 configured to recirculate ascites emitted or delivered from an outer surface of the ex vivo live 4 to the perfusate container 20.

Further, the system comprises a means 80 for determining a volume of bile 6 secreted by the ex vivo liver 4. The means 80 for determining a volume of bile may comprise a bile duct tube 82 connected to the bile duct 10 of the ex vivo liver 4 and a bile flow sensor 84 connected to the bile duct tube 82 for measuring a flow of bile 6 through the bile duct tube 82.

The system may further comprise a bile container 26 for receiving a volume of bile 6 secreted by the ex vivo liver 4. The bile container 26 may be connected to the bile duct tube 82.

The means 80 for determining a volume of bile alternatively or additionally may comprise a scale for measuring a mass of secreted bile 6 received within the bile container 26, or optically measure said volume, e.g., by means of a measurement scale.

Preferably, the means 80 are further or additionally for determining a bile production rate. For example, flow sensor 84 may be used for determination of a flow rate of bile and thus a bile production rate or of a change in volume per time. This may, alternatively, also established by means of the above mentioned scale or optical means associated with timing means to determine a change in weight/volume over time and thus determine a bile production rate.

A method for a NMP of an ex vivo liver comprises the following steps: (a) generating a flow of a perfusate 2 through an ex vivo liver 4, (b) stimulating a bile secretion of the ex vivo liver 4, and (c) determining a volume of bile 6 secreted by the ex vivo liver 4, and subsequently adding an oxygen carrier, e.g. in the form of whole blood 8 to the perfusate 2, wherein the added whole blood 8 has a volume that equals at least 70% of the determined volume of secreted bile 6. Alternatively, step (c′) may comprise adding whole blood to the perfusate 2 such that a volume of the perfusate 2 is held within a predetermined volume range.

Step (a) may be carried out particularly under use of the pump 24 and the oxygenator 40. Step (b) may be carried out by administering a bile salt 12 or a derivative thereof to the perfusate 2. Step (c) may be carried out under use of the means 80 for determining a volume of bile 6 secreted by the ex vivo liver 4.

Step (b) may be carried out for example once a day. Step (c) may be carried out for example twice a day, for example every 12 hours.

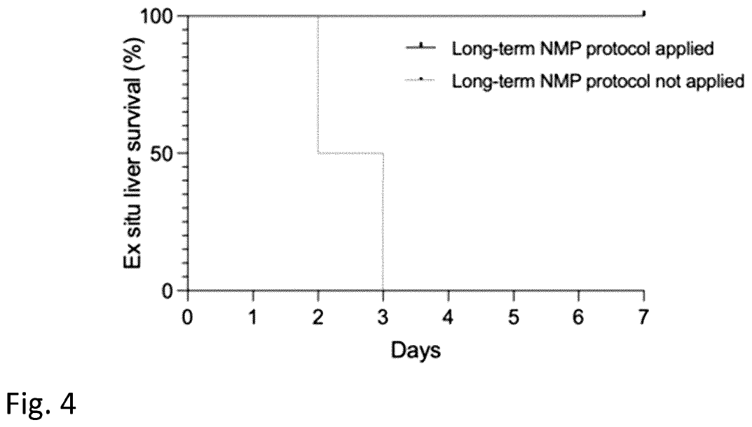

As schematically illustrated in FIG. 4, the method according to the present description allows a successful NMP for up to seven days (continuous line). If the method is not applied, organ function and morphology integrity severely impair after 48 hours (dotted line).

Preferably, step (b) is carried out in a controlled way. Specifically, a measurement or estimation of a recent bile secretion rate, i.e. a bile secretion of the ex vivo liver per time may be used to determine a dosage of bile salt 12 or its derivative administered in step (b), particular in such a way that a bile production is thereby effected which lies within a certain desired range.

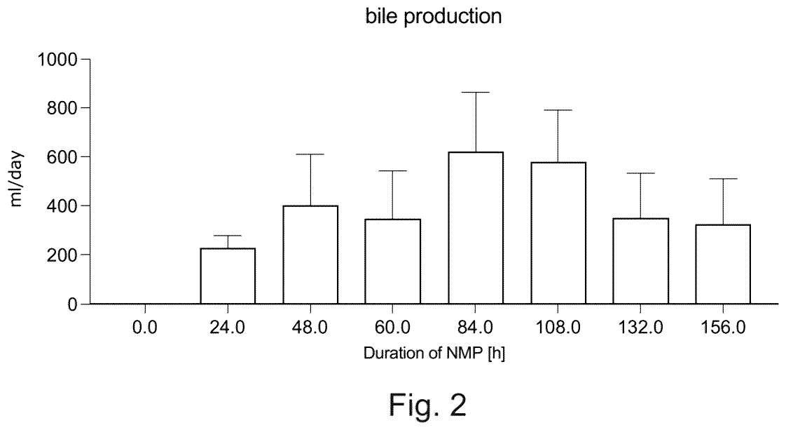

FIG. 2 shows a diagram exemplarily illustrating a bile production over time, measured during a method according to the present description. The bile production was controlled via a series of steps (b) as described herein. As can be seen, bile production can be kept within a desired range, for example within 100 and 1000 mL per day over the entire time during which the method is carried out. Controlling bile production to be within a desired range is particularly important with respect to the viability of the liver cells.

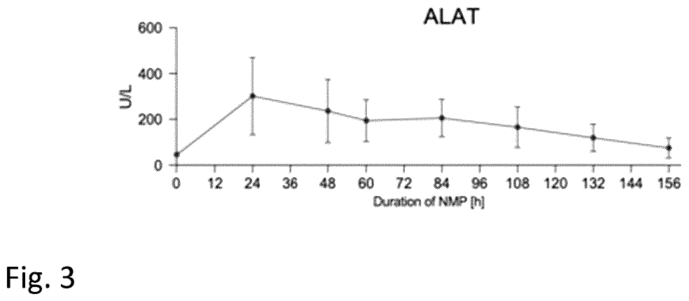

Similarly, FIG. 3 is a diagram exemplarily illustrating an alanine-aminotransferase (ALAT) level, measured during a method according to the present description. As can be taken from this diagram, the ALAT level can be kept stable within a certain desired range until the seventh day of perfusion according to the present method.

Further, the method may comprise administering an antibiotic 14 or a combination of antibiotics and preferably an antifungal agent to the perfusate

The following table shows an exemplary specific protocol for successful long-term NMP of porcine livers according to a method in line with the present description:

| Patient | | | | Start | Interval | Duration | |
|---|---|---|---|---|---|---|---|
| characteristics | Substance | Dosage | | (hour) | (hours) | (days) | Remarks |
| Infectious | | | | | | | |
| control | | | | | | | |
| Donor | meropenem | 1 | g | periop. | — | — | |
| Donor | vancomycin | 1 | g | periop. | — | — | |
| NMP | piperacillin/ | 0.9 | g | 0 | 24 | 7 | |
| | tazobactam | | | | | | |
| NMP | vancomycin | *10 mg/kg | | 24 | 24 | 7 | *adapted to |
| | | liver weight | | | | | target |
| | | | | | | | value: 10- |
| | | | | | | | 20 mg/L |
| NMP | meropenem | 10 mg/kg | | 24 | 24 | 7 | |
| | | liver weight | | | | | |
| NMP | fluconazole | 12 mg/kg | | 24 | 24 | 7 | |
| | | liver weight | | | | | |
| Perfusion | whole blood | 1500 | mL | 0 | | | |
| fluid | whole blood | ** | | 24 | 12 | 7 | **dosage |
| | | | | | | | equals daily |
| | | | | | | | volume loss |
| | | | | | | | due to bile |
| | | | | | | | production |
| Bile | | | | | | | |
| production | | | | | | | |
| Bile salt | sodium | 2.3 g-5.6 g/ | | | 24 | 7 | |
| | taurocholate | 30 mL saline | | | | | |
| Flushing of | saline | 2-5 | mL | 0 | 8 | 7 | |
| bile duct | | | | | | | |
| Glucose | glucose 33% | 10 | mL | — | — | — | if glucose |
| management | | | | | | | levels <15 |
| | | | | | | | mg/dL |
| | human | 50-200 IU | | 0 | continuous | | |
| | insulin | ad 30 mL | | | (1.25 ml/h) | | |
| | | saline | | | | | |
| Vasodilation | epoprostenol | 0.5 mg/10 | | 0 | continuous | 7 | |
| | prostacyclin | mL glycin | | | (1.25 ml/h) | | |
| | | buffer/30 | | | | | |
| | | mL saline | | | | | |
| Nutrition | Nutriflex ® | 1000 | mL | 0 | continuous | 7 | |
| | parenteral | | | | (1.25 ml/h) | | |
| | nutrition | | | | | | |
| | formula | | | | | | |
| pH control | sodium | 20 | mL | 2 | — | — | |
| | bicarbonate | | | | | | |
| Anticoagulation | HMW | 25.000 IU/ | | | continuous | | adapted to |
| | heparin | 30 mL saline | | | (1.25 ml/h) | | target |
| | | | | | | | value: >160 s |
| Protection | UV | — | | 0 | continuous | 7 | |
| from daylight | impermeable | | | | | | |
| | film on tubes/ | | | | | | |
| | syringes | | | | | | |

HMW: high molecular weight
**whole blood was retrieved from the donor animal before cross clamp
periop.: perioperatively

Preferably, the system further comprises means for generating a bile alarm if the volume of bile 6 determined by the means 80 for determining a volume of bile reaches a predetermined upper threshold value. In this way, a user of the system can be warned if a bile production rate exceeds an upper desired level.

Preferably, the system further comprises means for determining a volume of perfusate 2, e.g. the perfusate held in the perfusate container 20 or of the perfusate in the system, and means for generating a perfusate alarm if the volume of perfusate determined by the means for determining a volume of perfusate held in the perfusate container 20 drops below a preset lower threshold value. In this way, a user can be warned when an amount of perfusate 2 in the container 20 drops below a certain minimum level. This is of importance as a minimum level of perfusate 2 is necessary to keep up hepatocytes of the ex vivo liver viable. Means for measuring a volume of perfusate can be sensors, e.g., scales for measuring a mass perfusate received within the bile container 26, or optically measure said volume, e.g., by means of a measurement scale and/or a camera.

1. A method for a normothermic machine perfusion of an ex vivo liver, comprising the following steps:
(a) generating a flow of a perfusate through an ex vivo liver,
(b) stimulating a bile secretion of the ex vivo liver,
(c) determining a volume of bile secreted by the ex vivo liver, and subsequently adding an oxygen carrier, for example an oxygen carrier comprising or consisting of whole blood and/or red blood cells to the perfusate, wherein the added oxygen carrier has a volume that equals at least 20% of the determined volume of secreted bile.

2. The method of claim 1, wherein in step (c), the added oxygen carrier has a volume that equals at least 30%, preferably at least 40%, preferably at least 50%, preferably at least 60%, preferably at least 70%, preferably at least 75%, preferably at least 80%, preferably at least 85%, preferably at least 90%, preferably at least 95%, preferably at least 100% of the determined volume of secreted bile.

3. The method of claim 1, wherein in step (c) determining a volume of bile secreted by the ex vivo liver comprises measuring and/or estimating a volume of bile secreted by the ex vivo liver.

4. The method of claim 1, wherein step (c) is carried out at least twice, preferably at least three times, preferably at least four times, preferably at least five times, preferably at least six times, preferably at least eight times, preferably at least ten times, preferably at least twelve times, preferably at least fourteen times, and/or
wherein step (b) is carried out at least twice, preferably at least three times, preferably at least four times, preferably at least five times, preferably at least six times, preferably at least seven times.

5. The method of claim 1, wherein step (b) and/or step (c) is or are carried out, respectively, once within a predetermined time interval, wherein preferably the time interval is between 1 hour and 48 hours, preferably between 3 hours and 36 hours, preferably between 6 hours and 24 hours, preferably between 9 hours and 18 hours.

6. The method of claim 1, wherein a development over time of a bile production rate is determined and, based on this, a point in time is determined at which a subsequent method step for influencing the state of the ex vivo liver, for example in the form of stimulating a bile secretion of the ex vivo liver, preferably according to step (b), and/or adding an oxygen carrier, preferably according to step (c), is carried out.

7. The method of claim 1, wherein step (c) is carried out i times, wherein i is a natural number greater than 2, at successive times t1 to ti, i.e. a sequence of steps (c)(t1) to c(ti), whereby time tk, with 3≤k≤i, is determined depending on the preceding times tₖ₋₂ and tₖ₋₁, and the volumes of bile measured at the preceding steps (c)(tk-2) and (c)(tk-1).

8. The method of claim 7, wherein a first bile production rate between time tk-2 and a preceding time t0 and a second bile production rate between time tk-2 and tk-1 are determined and, if the second bile production rate is smaller than the first bile production rate, tk is determined such that tk minus tk-1 is less than tk-1 minus tk-2.

9. The method of claim 1, wherein
the method is carried out over a period of at least three days, preferably at least four days, preferably at least five days,
preferably at least six days, preferably at least seven days.

10. The method of claim 1, further comprising a step (d) of flushing a bile duct tube connected to the ex vivo liver, wherein, preferably, step (d) comprises flushing a volume of a flushing fluid, for example comprising saline, through the bile duct tube, wherein, preferably, the volume of the flushing fluid is taken into consideration when determining the volume of bile secreted by the ex vivo liver in step (c) carried out after step (d).

11. The method of claim 1, wherein in step (b) a bile salt or a derivative thereof is used for stimulating the bile secretion, wherein preferably the bile salt comprises or is sodium taurocholate and/or sodium glycocholate.

12. The method of claim 11, wherein the bile salt is administered to the perfusate in a dosage of up to 6 g per 24 hours, preferably up to 5 g per 24 hours, for example up to 4 g per 24 hours, and/or, wherein the average dosage of bile salt per day, administered during the period the method is carried out, is less than 5 g, preferably less than 4 g and more preferably between 2 and 3 g.

13. The method of claim 1, wherein, before step (b) is carried out, a bile secretion of the ex vivo liver per time is measured, and step (b) is controlled in dependence on the measured bile secretion per time, particularly by selecting a specific dosage of bile salt or a derivative thereof to be administered subsequently in step (b).

14. The method of claim 1, further comprising the following step:
(e) administering an antibiotic or a combination of antibiotics to the perfusate, preferably administering an antibiotic or a combination of antibiotics and an antifungal agent to the perfusate.

15. A method for a normothermic machine perfusion of an ex vivo liver, comprising the following steps:
(a) generating a flow of a perfusate through the ex vivo liver,
(b) stimulating a bile secretion of the ex vivo liver,
(c′) adding an oxygen carrier, for example an oxygen carrier comprising or consisting of whole blood and/or red blood cells to the perfusate such that a volume of the perfusate is held within a predetermined volume range.

16. A system for a normothermic machine perfusion of an ex vivo liver, particularly system for carrying out a method of any of the preceding claims, comprising
a perfusate container for receiving a perfusate,
an ex vivo liver container for holding the ex vivo liver,
a pump for generating a flow of the perfusate through the ex vivo liver,
means for determining a volume of bile secreted by the ex vivo liver,
and/or means for determining a volume of perfusate, and/or
means for determining a bile production rate.

17. The system of claim 16, further comprising
a bile container for receiving a volume of bile secreted by the ex vivo liver, and/or
an oxygenator for oxygenating the perfusate, wherein preferably the oxygenator is configured to oxygenate the perfusate for at least four days, preferably at least five days, preferably at least six days, preferably at least seven days.

18. The system of claim 16, further comprising
means for generating a bile alarm if the volume of bile determined by the means for determining a volume of bile secreted by the ex vivo liver reaches a predetermined upper threshold value, and/or
means for determining a volume of perfusate held in the perfusate container, and preferably means for generating a perfusate alarm if the volume of perfusate determined by the means for determining a volume of the perfusate held in the perfusate container reaches a predetermined lower threshold value.

19. The system of claim 16, further comprising means for automatically carrying out the steps of the method.
